(19) United States
(12) Patent Application Publication
(10) Pub. No.: US 2024/0022477 A1
(43) Pub. Date: Jan. 18, 2024

(54) PLACEMENT OF VIRTUAL COMPUTING INSTANCES (VCIs) BASED ON PHYSICAL NETWORK INTERFACE CONTROLLER (NIC) QUEUE INFORMATION

(71) Applicant: VMware, Inc., Palo Alto, CA (US)

(72) Inventor: Ankur Kumar SHARMA, Mountain View, CA (US)

(21) Appl. No.: 17/812,277

(22) Filed: Jul. 13, 2022

(51) Int. Cl. H04L 41/0895; H04L 41/0806

(52) U.S. Cl. CPC H04L 41/0895; H04L 41/0806; H04L 49/70

(57) ABSTRACT

The disclosure provides an approach for virtual computing instance (VCI) placement. Embodiments include receiving, by a resource optimization system, physical network interface (NIC) queue availability information relating to a plurality of host computers. Embodiments include determining, by the resource optimization system, physical NIC queue requirements of a VCI. Embodiments include selecting, by the resource optimization system, a target host computer for the VCI from the plurality of host computers based on the physical NIC queue availability information and the physical NIC queue requirements of the VCI. Embodiments include loading, by the resource optimization system, the VCI on the target host computer.

### BACKGROUND

Software defined networking (SDN) comprises a plurality of hosts in communication over a physical network infrastructure, each host having one or more virtualized endpoints such as virtual machines (VMs), containers, or other virtual computing instances (VCIs) that are connected to logical overlay networks that may span multiple hosts and are decoupled from the underlying physical network infrastructure. Though certain aspects are discussed herein with respect to VMs, it should be noted that they may similarly be applicable to other suitable VCIs.

Any arbitrary set of VCIs in a datacenter may be placed in communication across a logical Layer 2 network by connecting them to a logical switch. A logical switch is collectively implemented by at least one virtual switch on each host that has a VCI connected to the logical switch. Virtual switches provide packet forwarding and networking capabilities to VCIs running on the host. The virtual switch on each host operates as a managed edge switch implemented in software by the hypervisor on each host. As referred to herein, the terms “Layer 2,” “Layer 3,” etc. refer generally to network abstraction layers as defined in the OSI model. However, these terms should not be construed as limiting to the OSI model. Instead, each layer should be understood to perform a particular function which may be similarly performed by protocols outside the standard OSI model. As such, methods described herein are applicable to alternative networking suites.

SDN generally involves the use of a management plane (MP) and a control plane (CP). The management plane is concerned with receiving network configuration input from an administrator or orchestration automation and generating desired state data that specifies how the logical network should be implemented in the physical infrastructure. The management plane may have access to a database application for storing the network configuration input. The control plane is concerned with determining the logical overlay network topology and maintaining information about network entities such as logical switches, logical routers, endpoints, etc. The logical topology information specifying the desired state of the network is translated by the control plane into network configuration data that is then communicated to network elements of each host. The network configuration data, for example, includes forwarding table entries to populate forwarding tables at virtual switch(es) provided by the hypervisor (i.e., virtualization software) deployed on each host. An example control plane logical network controller is described in U.S. Pat. No. 9,525,647 entitled “Network Control Apparatus and Method for Creating and Modifying Logical Switching Elements,” which is fully incorporated herein by reference.

The rapid growth of network virtualization has led to an increase in large scale SDN data centers. The scale of such data centers may be very large, often including hundreds of servers with each server hosting hundreds of VCIs. With such scale comes a need to be able to operate such topologies efficiently and avoid errors that may result in downtime. There are tools that troubleshoot network connectivity issues and help to provide a highly available network infrastructure, such as through load balancing based on processor and memory utilization on hosts. One or more components in the SDN may handle the placement and migration of workloads, such as VCIs, on hosts in order to achieve load balancing. However, not all network issues are a result of processor or memory load. Other factors relating to networking environments can also affect the functioning of VCIs on hosts.

It should be noted that the information included in the Background section herein is simply meant to provide a reference for the discussion of certain embodiments in the Detailed Description. None of the information included in this Background should be considered as an admission of prior art.

### BRIEF DESCRIPTION OF THE DRAWINGS

FIG. 1 depicts example physical and virtual computing components with which embodiments of the present disclosure may be implemented.

FIG. 2 depicts an example of placement of VCIs on hosts based on physical network interface controller (NIC) queue availability information according to embodiments of the present disclosure.

FIG. 3 depicts an example of additional aspects related to placement of VCIs on hosts based on physical network interface controller (NIC) queue availability information according to embodiments of the present disclosure.

FIG. 4 depicts example operations for placement of VCIs on hosts based on physical network interface controller (NIC) queue availability information according to embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for incorporating physical network interface controller (NIC) queue availability information in virtual computing instance (VCI) placement determinations. While some existing techniques for VCI placement involve considering physical resource utilization, such as processor and memory utilization, at hosts in order to select a host on which to place a VCI, these techniques may not be effective at preventing certain errors and inefficiencies. For example, existing VCI placement engines do not take into consideration physical NIC queue availability, which is a resource that is critical for high performance workloads such as VCIs that perform network function virtualization (NFV) functionality. NFV is the replacement of physical network appliances with VCIs that perform processes such as routing and load balancing.

A physical NIC (which may be referred to as a PNIC) generally exposes multiple circular buffers called queues for transferring packets. A given PNIC may have one or more receive queues and one or more transmit queues. If there are multiple transmit queues, these are merged by the PNIC for transmission of packets (e.g., according to the presence of packets in queues, priorities associated with queues, and/or other rules). If there are multiple receive queues, incoming traffic is generally split according to filters, hashing algorithms, rules, and/or other criteria. Both receive and transmit queues work in a similar way. The PNIC driver generally programs a physical base address and size of the queue, and then fills the memory area with direct memory access (DMA) descriptors (e.g., pointers to physical addresses where packet data is stored) and associated metadata. Packets are sent and received by passing ownership of the DMA descriptors between the driver and the hardware of the PNIC.

In some cases, VCIs may have certain requirements related to PNIC queueing in order to achieve an expected level of performance. A VCI may, for instance, require one or more dedicated processor threads for processing of network packets (e.g., due to a high performance requirement of the VCI), which leads to a requirement for one or more dedicated PNIC queues. For example, each PNIC queue may be assigned a separate thread (or core) of a processing device such as a central processing unit (CPU) associated with the PNIC. Certain PNICs may be configured to distribute packets among queues based on attributes, called filters. Many PNICs support the use of outer media access control (MAC) addresses as filters and, as a result, packets with the same destination MAC addresses may be handled by a single queue. This can be problematic for certain types of network traffic, such as where packets addressed to multiple endpoints (e.g., VCIs) will have a single destination MAC address in the outer header. As such, to overcome this problem, some PNICs are configured to filter based on the inner packet MAC address. Thus, certain PNICs have the ability to filter packets in such a manner as to provide dedicated receive and transmit queues to particular VCIs. This ability may be referred to as pinning (e.g., as it allows a PNIC queue to be “pinned” to a VCI for use exclusively by that VCI).

In another example, a VCI may expect its network traffic load to be shared among multiple processor threads, which leads to a requirement of utilizing receive side scaling (RSS). RSS overcomes additional limitations associated with dedicated PNIC queues. For instance, dedicated PNIC queues generally operate based on MAC address filters, which means that packets belonging to same MAC address will be processed by the same queue. Thus, with a dedicated PNIC queue, a virtual NIC (VNIC) of a VCI receives packets from only one queue and, as a result, performance may be limited. RSS allows distribution of packets among multiple PNIC queues based on flows and, accordingly, a single VNIC with multiple flows can leverage parallelism with respect to the PNIC and CPU using multiple PNIC queues. The distribution can vary among various PNICs, as some PNICs support 5-tuple hashing techniques (e.g., thereby allowing flow-based distribution) while other PNICs do not.

RSS generally involves grouping PNIC queues into “RSS engines,” where each RSS engine comprises one or more PNIC queues. A VCI may, for example, be assigned an RSS engine of a PNIC for processing of incoming traffic. The “size” of an RSS engine refers to the number of PNIC queues in the RSS engine. In some cases, a corresponding transmit queue is associated with each receive queue in an RSS engine, and flows that are processed by a given receive queue in the RSS engine (for incoming traffic) are processed by the corresponding transmit queue (for outgoing traffic).

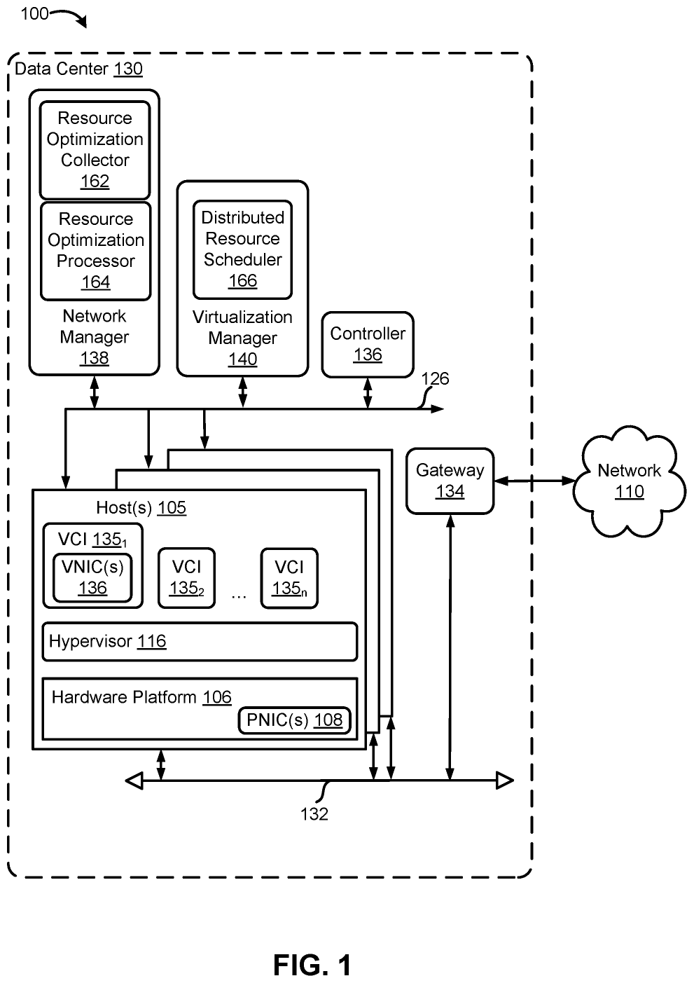

Embodiments of the present disclosure involve collecting data about PNIC queue availability on hosts, including information about numbers of active PNICs on a host, whether a host supports dedicated PNIC queues and/or RSS, how many receive and/or transmit queues and/or RSS engines are available on a host, sizes of RSS engines, and/or the like. In some embodiments, a collector component of a resource optimization system resides in a management plane and collects PNIC queue availability data about each host, as described in more detail below with respect to FIG. 1. The collector component provides this information to a processor component of the resource optimization system. The processor component may, for instance, run on a management server or on a VCI on a host (or, alternatively, may be distributed across multiple VCIs) in order to offload processing tasks from the management plane (e.g., so as not to overburden the server on which management plane components reside).

In certain embodiments, the processor component performs processing related to determining a host on which to place a given VCI based on PNIC queue availability. In an example, the processing component receives a request from a distributed resource scheduler (DRS) to recommend one or more hosts for placement of a VCI. The DRS generally represents a component of the resource optimization system that handles VCI placement, such as initial placement of VCIs and/or the migration of VCIs between hosts for load balancing and other purposes.

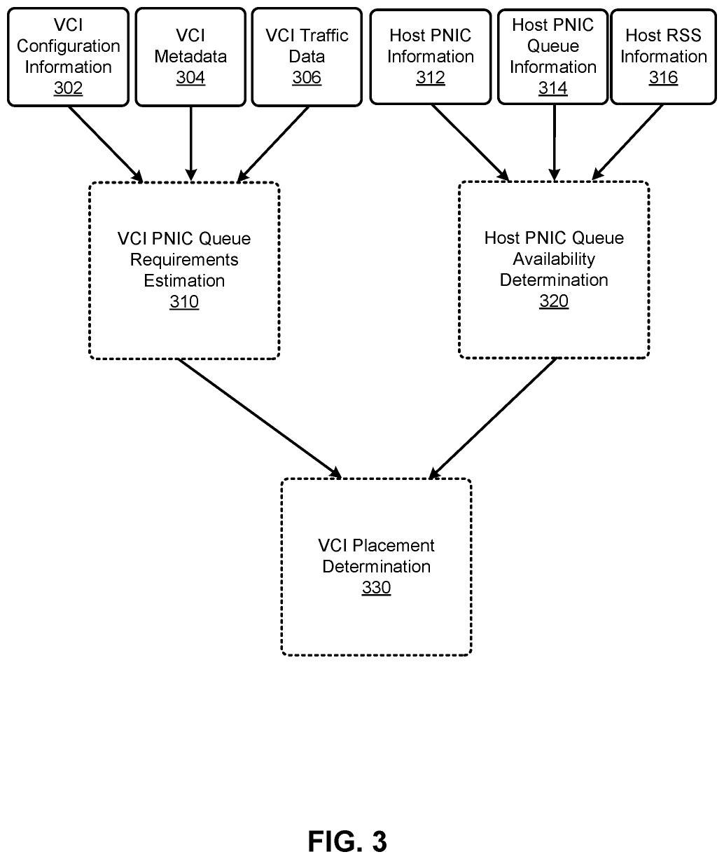

Upon receiving a request from the DRS for a recommendation related to a placement of a VCI, the processor component determines PNIC queue requirements of the VCI. In an example, the processor component determines PNIC queue requirements of the VCI based on a number of VNICs of the VCI and/or other configuration information of the VCI, metadata associated with the VCI (e.g., tags added by an administrator that explicitly indicate PNIC queue requirements, performance requirements, and/or purposes of the VCI), actual traffic data related to the VCI (e.g., if the VCI is already running on a host), and/or the like, as described in more detail below with respect to FIG. 3. PNIC queue requirements of a VCI may include one or more dedicated receive and/or transmit queues, a number of available RSS engines (e.g., having a certain size), a number of available receive and/or transmit queues (e.g., whether dedicated or not), a maximum number of other VCIs with which the VCI can share one or more receive and/or transmit queues and/or RSS engines, and/or the like.

The processor component then uses the PNIC queue availability information for the hosts received from the collector component in conjunction with the PNIC queue requirements of the VCI to determine one or more hosts on which the VCI may be placed, as described in more detail below with respect to FIG. 3.

In some embodiments, the processor component responds to the request from the DRS with a list of hosts on which the VCI can be placed. In certain embodiments, the processor component ranks the hosts. For instance, hosts that support dedicated PNIC queues and/or RSS engines, with a larger number of available PNIC queues and/or RSS engines, RSS engines of a larger size, and/or smaller numbers of other VCIs may be ranked higher than hosts that do not provide these benefits. This ranking may be achieved, for example, by computing scores for hosts based on a variety of factors (e.g., including factors related to PNIC queue availability information and/or other factors such as availability of other logical networking resources). In other embodiments, the PNIC queue availability information is only used to eliminate hosts on which the VCI cannot be placed without poor performance.

The DRS may select a host on which to place the VCI based on the one or more hosts recommended by the processor component. In some embodiments, the DRS also bases its selection on additional information, such as physical resource utilization information for the hosts. For example, the DRS may receive processor utilization and memory utilization information for each host, and may select a host based on processor utilization and memory utilization as well as recommendations from the processor component.

Once the DRS selects a host on which to place the VCI, the VCI is placed on the selected host. In some embodiments, the VCI is placed on the selected host by a migration component of the resource optimization system, which may also reside in the management plane. As such, techniques described herein allow VCIs to be placed on hosts based on both physical resource utilization and PNIC queue availability information from the hosts.

It is noted that while certain embodiments involve a collector component, a processor component, and a DRS as separate components, the functionality described with respect to these components may be performed by one or more components on the same and/or different computing devices.

FIG. 1 depicts example physical and virtual network components with which embodiments of the present disclosure may be implemented.

Networking environment 100 includes data center 130 connected to network 110. Network 110 is generally representative of a network of computing entities such as a local area network (“LAN”) or a wide area network (“WAN”), a network of networks, such as the Internet, or any connection over which data may be transmitted.

Data center 130 generally represents a set of networked computing entities, and may comprise a logical overlay network. Data center 130 includes host(s) 105, a gateway 134, a data network 132, which may be a Layer 3 network, and a management network 126. Data network 132 and management network 126 may be separate physical networks or different virtual local area networks (VLANs) on the same physical network.

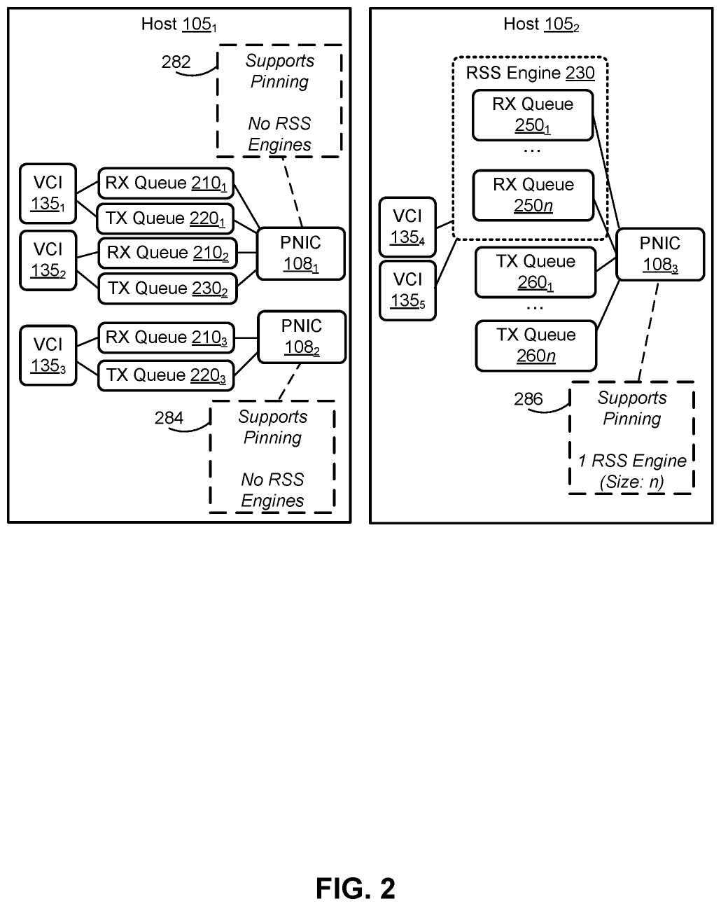

Each of hosts 105 may be constructed on a server grade hardware platform 106, such as an x86 architecture platform. For example, hosts 105 may be geographically co-located servers on the same rack or on different racks. Host 105 is configured to provide a virtualization layer, also referred to as a hypervisor 116, that abstracts processor, memory, storage, and networking resources of hardware platform 106 into multiple virtual computing instances (VCIs) 135₁ to 135ₙ (collectively referred to as VCIs 135 and individually referred to as VCI 135) that run concurrently on the same host. VCIs 135 may include, for instance, VMs, containers, virtual appliances, and/or the like. VCI 135₁ is associated with one or more virtual network interface controllers (VNICs) 136. Other VCIs 135 may also be associated with VNICs. A VNIC is a software component (e.g., a VCI) that provides NIC functionality using abstracted resources of an underlying physical NIC (PNIC). For example, VNIC(s) 136 may provide NIC functionality for one or more VCIs 135 based on abstracted resources of PNIC(s) 108 of a host 105. As described in more detail below, VNIC(s) 136 may be assigned receive (RX) queues and/or transmit (TX) queues exposed by PNIC(s) 108 for processing of network traffic, as described in more detail below with respect to FIGS. 2 and 3.

Hypervisor 116 may run in conjunction with an operating system (not shown) in host 105. In some embodiments, hypervisor 116 can be installed as system level software directly on hardware platform 106 of host 105 (often referred to as “bare metal” installation) and be conceptually interposed between the physical hardware and the guest operating systems executing in the virtual machines. In certain aspects, hypervisor 116 implements one or more logical entities, such as logical switches, routers, etc. as one or more virtual entities such as virtual switches, routers, etc. In some implementations, hypervisor 116 may comprise system level software as well as a “Domain 0” or “Root Partition” virtual machine (not shown) which is a privileged machine that has access to the physical hardware resources of the host. In this implementation, one or more of a virtual switch, virtual router, virtual tunnel endpoint (VTEP), etc., along with hardware drivers, may reside in the privileged virtual machine. Although the disclosure is described with reference to VMs, the teachings herein also apply to other types of virtual computing instances (VCIs) or data compute nodes (DCNs), such as containers, which may be referred to as Docker containers, isolated user space instances, namespace containers, etc. In certain embodiments, VCIs 135 may be replaced with containers that run on host 105 without the use of a hypervisor.

Gateway 134 provides VCIs 135 and other components in data center 130 with connectivity to network 110, and is used to communicate with destinations external to data center 130 (not shown). Gateway 134 may be a virtual computing instance, a physical device, or a software module running within host 105.

Controller 136 generally represents a control plane that manages configuration of VCIs 135 within data center 130. Controller 136 may be a computer program that resides and executes in a central server in data center 130 or, alternatively, controller 136 may run as a virtual appliance (e.g., a VM) in one of hosts 105. Although shown as a single unit, it should be understood that controller 136 may be implemented as a distributed or clustered system. That is, controller 136 may include multiple servers or virtual computing instances that implement controller functions. Controller 136 is associated with one or more virtual and/or physical CPUs (not shown). Processor(s) resources allotted or assigned to controller 136 may be unique to controller 136, or may be shared with other components of data center 130. Controller 136 communicates with hosts 105 via management network 126.

Network manager 138 and virtualization manager 140 generally represent components of a management plane comprising one or more computing devices responsible for receiving logical network configuration inputs, such as from a network administrator, defining one or more endpoints (e.g., VCIs and/or containers) and the connections between the endpoints, as well as rules governing communications between various endpoints. In one embodiment, network manager 138 is a computer program that executes in a central server in networking environment 100, or alternatively, network manager 138 may run in a VM, e.g. in one of hosts 105. Network manager 138 is configured to receive inputs from an administrator or other entity, e.g., via a web interface or API, and carry out administrative tasks for data center 130, including centralized network management and providing an aggregated system view for a user.

In an embodiment, virtualization manager 140 is a computer program that executes in a central server in data center 130 (e.g., the same or a different server than the server on which network manager 138 executes), or alternatively, virtualization manager 140 runs in one of VCIs 135. Virtualization manager 140 is configured to carry out administrative tasks for data center 130, including managing hosts 105, managing VCIs 135 running within each host 105, provisioning VCIs 135 on hosts 105, transferring VCIs 135 from one host to another host, transferring VCIs 135 between data centers, transferring application instances between VCIs 135 or between hosts 105, and load balancing among hosts 105 within data center 130. Virtualization manager 140 takes commands from components located on control network 126 as to creation, migration, and deletion decisions of VCIs 135 and application instances on data center 130. However, virtualization manager 140 also makes independent decisions on management of local VCIs 135 and application instances, such as placement of VCIs 135 and application instances between hosts 105. Virtualization manager 140 includes a distributed resource scheduler (DRS) 166. In some embodiments, virtualization manager 140 also includes a migration component that performs migration of VCIs between hosts 105, such as by live migration, and/or such functionality may be performed by DRS 166.

Network manager 138 includes a resource optimization collector 162 that collects PNIC queue availability information for hosts 105. This information may be provided to resource optimization collector 162 by network manager 138, by individual hosts 105, and/or by one or more other components that maintain information about available computing resources on hosts. PNIC queue availability information is described in more detail below with respect to FIG. 3. Resource optimization collector 162 provides the PNIC queue availability information to resource optimization processor 164, which performs processing related to determining hosts on which to place VCIs.

While resource optimization processor 164 is depicted on network manager 138, resource optimization processor 164 may alternatively be located on a VCI, virtualization manager 140, or another local or remote location. In some embodiments, resource optimization processor 164 is distributed across a plurality of VCIs.

Resource optimization processor 164 receives requests from DRS 166 to recommend (or recommend against) one or more of hosts 105 on which to place a VCI. For example, DRS 166 may identify a VCI that is to be placed on a host, and may provide resource optimization processor 164 with one or more attributes of the VCI that relate to PNIC queue requirements of the VCI, as described in more detail below with respect to FIG. 3. Resource optimization processor 164 determines PNIC queue requirements for the VCI based on the received information.

Resource optimization processor 164 then determines, based on the PNIC queue requirements of the VCI and the PNIC queue availability information of the hosts if any hosts 105 meets the PNIC queue requirements of the VCI. If a given host 105 does not meet the PNIC queue requirements of the VCI, then the given host 105 is excluded (e.g., except, in some embodiments, if no hosts 105 meet all of the PNIC queue requirements of the VCI, in which case a suboptimal choice may need to be made). Once all hosts that can fulfill the PNIC queue requirements for the VCI are identified, a target host may be selected for the VCI based on which host (or hosts) best optimizes the PNIC queue requirements of the VCI (e.g., a host with the largest number of available PNIC queues, RSS engines, and/or the like, and/or a host with the smallest number of other VCIs).

In some embodiments, resource optimization processor 164 ranks hosts 105 based on the extent to which each host 105 meets the PNIC queue requirements of the VCI. In an alternate embodiment, resource optimization processor 164 identifies one or more hosts 105 that do not meet the PNIC queue requirements of the VCI as hosts that should be excluded from consideration for placing the VCI. In some cases, ranking and/or scoring of hosts 105 for placement of the VCI could also factor in the extent to which other VCI are already present on each host 105, and/or the extent to which other VCIs utilize PNIC queues and/or RSS engines of each host 105.

Resource optimization processor 164 then provides the one or more selected hosts 105 as recommendations (and/or other relevant information such as exclusions, ranking, and/or scoring) to DRS 166 (e.g., ordered according to rank). DRS 166 selects a host 105 on which to place the VCI based on the recommendations and, in some embodiments, based also on other factors such as processor and memory utilization on hosts 105. Once a host 105 is selected, virtualization manager 140 places the VCI on the host 105.

It is noted that resource optimization collector 162, resource optimization processor 164, DRS 166, and other components of virtualization manager 140 and/or network manager 138 that perform operations related to placement of VCIs on hosts may be referred to collectively as a resource optimization system. In alternative embodiments, the resource optimization system is implemented as a single component.

FIG. 2 depicts an example of placement of VCIs on hosts based on physical network interface controller (NIC) queue availability information according to embodiments of the present disclosure. Example 200 includes hosts 105₁ and 105₂, VCIS 135₁₋₅, and PNICS 108₁₋₃, which generally represent instances of hosts 105, VCIs 135, and PNICs 108 of FIG. 1.

Host 105₁ comprises two PNICs 108₁ and 108₂. PNIC 108₁ has configuration 282, indicating that PNIC 108₁ supports pinning (e.g., dedicated PNIC queues) and does not include any RSS engines. PNIC 108₁ has two receive (RX) queues 210₁ and 210₂ and two transmit (TX) queues 220₁ and 220₂. PNIC 108₂ has configuration 284, indicating that PNIC 108₂ supports pinning (e.g., dedicated PNIC queues) and does not include any RSS engines. PNIC 108₂ has one RX queue 210₃ and one TX queue 220₃.

Three VCIs 135₁₋₃ are placed on host 105₁, such as by DRS 166 of FIG. 1, based on PNIC queue availability information, as described in more detail below with respect to FIG. 3.

VCI 135₁ is pinned to RX queue 210₁ and TX queue 220₁. VCI 135₂ is pinned to RX queue 210₂ and TX queue 220₂. VCI 135₃ is pinned to RX queue 210₃ and TX queue 220₃.

Host 105₂ comprises one PNIC 108₃. PNIC 108₃ has configuration 286, indicating that PNIC 108₃ supports pinning (e.g., dedicated PNIC queues) and has one RSS engine of size n. PNIC 108₃ has n RX queues 250₁₋ₙ and n TX queues 260₁₋ₙ. RX queues 250₁₋ₙ are organized into an RSS engine 230.

Two VCIs 135₄ and 135₅ are placed on host 105₂, such as by DRS 166 of FIG. 1, based on PNIC queue availability information, as described in more detail below with respect to FIG. 3.

VCI 135₄ is assigned to RSS engine 230 and is not pinned to any particular TX queue. VCI 135₂ is assigned to RSS engine 230 and is also not pinned to any particular TX queue.

RSS engine 230 may allow for filtering based on flow (e.g., flows may be identified using a 5-tuple), such that incoming traffic for VCIs 135₄ and 135₅ may be placed into a given RX queue within RSS engine 230 based on flow. In some cases, TX queues 260 also filter based on flows, and traffic from either VCI 135₄ or VCI 135₅ may be placed in a given TX queue 260 based on flow.

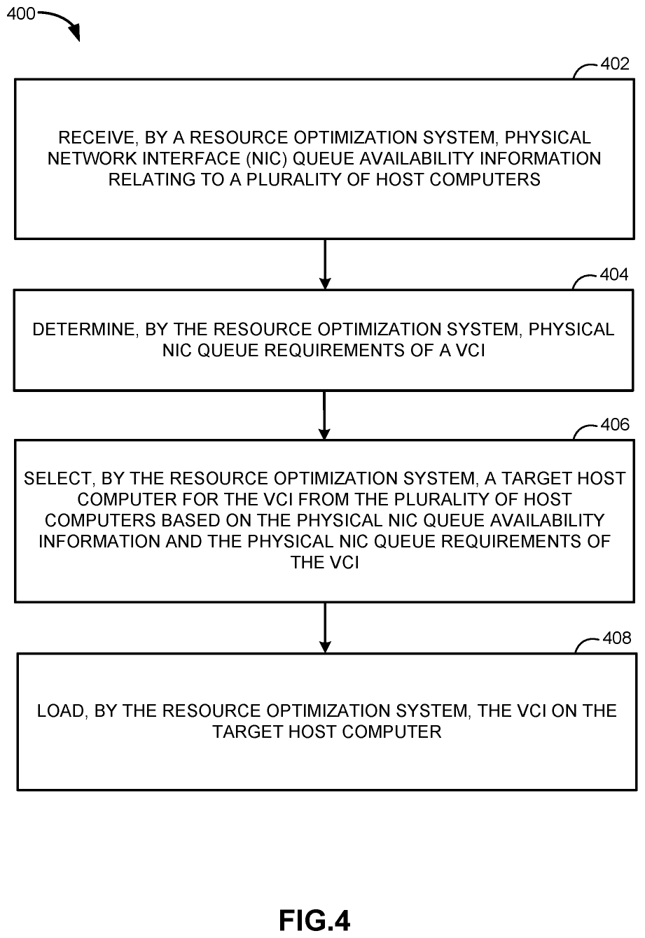

Techniques for placing VCIs on hosts based on PNIC queue availability information are described in more detail below with respect to FIGS. 3 and 4.

FIG. 3 depicts an example of additional aspects related to placement of VCIs on hosts based on physical network interface controller (NIC) queue availability information according to embodiments of the present disclosure.

VCI PNIC queue requirements estimation 310 is performed, such as by resource optimization processor 164 of FIG. 1, based on data related to a particular VCI 135 of FIG. 1. For example, VCI configuration information 302 may include a number of VNICs with which the VCI is configured, whether the VCI is configured to perform NFV functionality, and/or the like.

VCI metadata 304 may include tags assigned to the VCI (e.g., by an administrator) indicating specific PNIC queue requirements (e.g., requires pinning, requires RSS, requires x number of RX and/or TX queues), a level of expected network performance (e.g., low, medium, or high, a numerical value indicating a relative level of expected performance, a particular requirement with respect to a particular performance metric such as throughput and/or latency, and/or the like), one or more purposes of the VCI (e.g., whether the VCI performs NFV functionality, whether the VCI performs network and/or virtualization management functionality, and/or the like), and/or other attributes of the VCI.

VCI traffic data 306 represents actual observed network traffic of the VCI, which may be available in cases where the VCI is currently running on a host and the DRS is determining whether to migrate the VCI to a different host. For example VCI traffic data 306 may indicate a number of RX and/or TX packets transmitted in a given time period, a total size of all RX and/or TX packets transmitted in a given time period, and/or the like.

In some embodiments, VCI PNIC queue requirements estimation 310 involves applying rules and/or other types of logic to determine certain data points about the VCI's PNIC queue requirements. For example, a rule may state that a VCI with x VNICs should be placed on a host with x available RX and TX PNIC queues. In another example, a rule may state that a VCI that performs NFV functionality and/or that otherwise requires a high level of network performance is to be placed on a host with one or more PNICs that support pinning and/or RSS. In yet another example, a rule may state that a VCI with traffic data indicating a certain amount of RX and/or TX data is to be placed on a host with a number of available RX and/or TX queues and/or RSS engines (e.g., with a particular size) that is determined based on the certain amount of RX and/or TX data (e.g., using a formula).

Host PNIC queue availability determination 320 is performed, such as by resource optimization processor 164 of FIG. 1, based on PNIC availability information related to hosts 105 of FIG. 1, such as data received from resource optimization collector 162 of FIG. 1. PNIC availability information may include host PNIC information 312, host PNIC queue information 314, and/or host RSS information 316. Host PNIC information 312 generally includes a number of PNICs on a host, whether certain PNICs support dedicated queues (e.g., pinning), whether certain PNICs support RSS, and/or the like.

Host PNIC queue information 314 generally includes a number of RX and/or TX queues on a host, whether RX and/or TX queues are available for shared assignment and/or pinning, numbers of other VCIs assigned to RX and/or TX queues, and/or the like. Host RSS information 314 generally includes a number of RSS engines on a host, sizes of the RSS engines, numbers of other VCIs assigned to the RSS engines, numbers of other VCIs utilizing the PNIC queues and/or RSS engines of the PNIC(s) and/or the like. In some embodiments, host PNIC queue information 314 further includes information about non-uniform memory access (NUMA) nodes with which PNICs are associated, and numbers of VCIs associated with those NUMA nodes.

NUMA is a type of memory architecture that allows a processor faster access to contents of memory than other traditional techniques. In a NUMA architecture, each processor component (e.g., comprising one or more processors, cores/threads, and/or the like) is assigned a specific local memory exclusively for its own use. Generally, a plurality of nodes (also referred to as sockets) are defined, with each node including a processor component and a memory component. The processor component includes one or more cores and an associated cache. The memory component includes a portion of system memory. The processor component can access the memory component within the same node efficiently (e.g., memory in the same node is local to the processor component). The nodes are also interconnected with each other such that a processor component in one node can access a memory component in another node through an interconnection between the nodes. Each PNIC queue of a host may be assigned to a NUMA node, and that NUMA node may also be associated with one or more VCIs that run on the host. It may be advantageous to determine how many other VCIs share a NUMA node with a given PNIC queue in order to identify the processing and/or memory resources that may be locally available to the VCI that is being placed, and this information may be another factor used in the placement determination.

Host PNIC queue availability determination generally involves determining certain data points related to host PNIC queue availability based on the received information, such as numbers of PNICs on hosts, support for pinning and/or RSS, numbers of available RX and/or TX queues and/or RSS engines for shared assignment and/or pinning, how many other VCIs share a given queue and/or engine, and/or the like. For example, resource optimization processor 164 of FIG. 1 may determine that the VCI needs one or more dedicated and/or non-dedicated RX and/or TX queue for each VNIC, one or more RSS engines for each VNIC, and/or the like. Resource optimization processor 164 may, in some embodiments, determine a maximum number of other VCIs with which the VCI can share one or more PNIC queues and/or RSS engines (e.g., based on a level of network performance required by the VCI).

VCI placement determination 330 is performed based on VCI PNIC queue requirements estimation 310 and host PNIC queue availability determination, such as by resource optimization processor 164 and/or DRS 166 of FIG. 1.

In some embodiments, resource optimization processor 164 recommends one or more hosts on which to place the VCI and DRS 166 selects a host based on the recommendation(s) from resource optimization processor 164 and/or based on one or more additional factors (e.g., availability of other resources such as CPU and/or memory).

Resource optimization processor 164 may determine a host or hosts to recommend based on an extent to which each host complies with and/or exceeds the PNIC queue requirements of the VCI. In certain embodiments, hosts are scored based on the degree to which they correspond to each PNIC queue requirement of the VCI. For example, for a VCI that requires high network performance and dedicated RX and TX queues, a host that supports pinning, has an RX queue and a TX queue available for dedicated assignment to the VCI, and the available RX and TX queues are associated with NUMA nodes that are not associated with any other VCIs may be assigned a higher score than a host that also supports pinning and has an RX queue and a TX queue available for dedicated assignment to the VCI, but the RX queue and/or TX queue is associated with a NUMA node that is also associated with a plurality of other VCIs.

In certain embodiments, VCI placement may also involve determining whether the VCI should be placed on the same host as one or more other particular VCIs that have an affinity with the VCI (e.g., based on VCI metadata 304). For example, certain VCIs that communicate with each other may perform best if placed on the same host. As such, this affinity may be indicated in metadata, and may be used as a factor in determining a host on which to place the VCI.

VCI placement determination 330 may also involve assigning particular PNIC queues and/or RSS engines to the VCI in genera and/or to particular VNICs of the VCI. For example, with respect to FIG. 2, if VCI 135₁ has one VNIC, then that VNIC may be assigned to RX queue 210₁ and TX queue 220₁. Assignments of VCIs and/or VNICs to particular PNIC queues and/or RSS engines may be communicated by DRS 166 of FIG. 1 to the hypervisor of the host on which the VCI is placed, and the hypervisor may assign the PNIC queues and/or RSS engines accordingly.

FIG. 4 depicts example operations 400 for VCI placement according to embodiments of the present disclosure. For example, operations 400 may be performed by various components of a resource optimization system, such as resource optimization collector 162, resource optimization processor 164, DRS 166, and/or virtualization manager 140 of FIG. 1.

Operations 400 begin at step 402, with receiving, by a resource optimization system, physical network interface (NIC) queue availability information relating to a plurality of host computers. In some embodiments, the physical NIC queue availability information comprises one or more of: a number of active physical NICs; a number of available physical NIC queues for transmission or reception of data; a number of available receive side scaling (RSS) engines corresponding to a given physical NIC; a number of physical NIC queues in a given RSS engine corresponding to the given physical NIC; or an association between a given physical NIC queue and a non-uniform memory access (NUMA) node. In certain embodiments, the physical NIC queue availability information comprises information indicating an ability of one or more physical NICs to support pinning.

Operations 400 continue at step 404, with determining, by the resource optimization system, physical NIC queue requirements of a VCI. In some embodiments, determining the physical NIC queue requirements of the VCI comprises determining a number of virtual NICs associated with the VCI.

In certain embodiment, determining the physical NIC queue requirements of the VCI comprises determining configuration information for one or more virtual NICs associated with the VCI. Determining the physical NIC queue requirements of the VCI may also be based on records of network traffic associated with the VCI. In some embodiments, determining the physical NIC queue requirements of the VCI is based on metadata associated with the VCI.

Operations 400 continue at step 406, with selecting, by the resource optimization system, a target host computer for the VCI from the plurality of host computers based on the physical NIC queue availability information and the physical NIC queue requirements of the VCI. Certain embodiments further comprise selecting, by the resource optimization system, a particular physical NIC of the target host computer for association with the VCI based on the physical NIC queue availability information and the physical NIC queue requirements of the VCI.

Operations 400 continue at step 408, with loading, by the resource optimization system, the VCI on the target host computer.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of virtual computing instance (VCI) placement, comprising:
receiving, by a resource optimization system, physical network interface (NIC) queue availability information relating to a plurality of host computers;
determining, by the resource optimization system, physical NIC queue requirements of a VCI;
selecting, by the resource optimization system, a target host computer for the VCI from the plurality of host computers based on the physical NIC queue availability information and the physical NIC queue requirements of the VCI; and
loading, by the resource optimization system, the VCI on the target host computer.

2. The method of claim 1, wherein the physical NIC queue availability information comprises one or more of:
a number of active physical NICs;
a number of available physical NIC queues for transmission or reception of data;
a number of available receive side scaling (RSS) engines corresponding to a given physical NIC;
a number of physical NIC queues in a given RSS engine corresponding to the given physical NIC; or
an association between a given physical NIC queue and a non-uniform memory access (NUMA) node.

3. The method of claim 1, wherein the physical NIC queue availability information comprises information indicating an ability of one or more physical NICs to support pinning.

4. The method of claim 1, wherein determining the physical NIC queue requirements of the VCI comprises determining a number of virtual NICs associated with the VCI.

5. The method of claim 1, wherein determining the physical NIC queue requirements of the VCI comprises determining configuration information for one or more virtual NICs associated with the VCI.

6. The method of claim 1, wherein determining the physical NIC queue requirements of the VCI is based on records of network traffic associated with the VCI.

7. The method of claim 1, wherein determining the physical NIC queue requirements of the VCI is based on metadata associated with the VCI.

8. The method of claim 1, further comprising selecting, by the resource optimization system, a particular physical NIC of the target host computer for association with the VCI based on the physical NIC queue availability information and the physical NIC queue requirements of the VCI.

9. A system for virtual computing instance (VCI) placement, the system comprising:
at least one memory; and
at least one processor coupled to the at least one memory, the at least one processor and the at least one memory configured to:
receive, by a resource optimization system, physical network interface (NIC) queue availability information relating to a plurality of host computers;
determine, by the resource optimization system, physical NIC queue requirements of a VCI;
select, by the resource optimization system, a target host computer for the VCI from the plurality of host computers based on the physical NIC queue availability information and the physical NIC queue requirements of the VCI; and
load, by the resource optimization system, the VCI on the target host computer.

10. The system of claim 9, wherein the physical NIC queue availability information comprises one or more of:
a number of active physical NICs;
a number of available physical NIC queues for transmission or reception of data;
a number of available receive side scaling (RSS) engines corresponding to a given physical NIC;
a number of physical NIC queues in a given RSS engine corresponding to the given physical NIC; or
an association between a given physical NIC queue and a non-uniform memory access (NUMA) node.

11. The system of claim 9, wherein the physical NIC queue availability information comprises information indicating an ability of one or more physical NICs to support pinning.

12. The system of claim 9, wherein determining the physical NIC queue requirements of the VCI comprises determining a number of virtual NICs associated with the VCI.

13. The system of claim 9, wherein determining the physical NIC queue requirements of the VCI comprises determining configuration information for one or more virtual NICs associated with the VCI.

14. The system of claim 9, wherein determining the physical NIC queue requirements of the VCI is based on records of network traffic associated with the VCI.

15. The system of claim 9, wherein determining the physical NIC queue requirements of the VCI is based on metadata associated with the VCI.

16. The system of claim 9, wherein the at least one processor and the at least one memory are further configured to select, by the resource optimization system, a particular physical NIC of the target host computer for association with the VCI based on the physical NIC queue availability information and the physical NIC queue requirements of the VCI.

17. A non-transitory computer-readable medium storing instructions that, when executed by one or more processors, cause the one or more processors to:
receive, by a resource optimization system, physical network interface (NIC) queue availability information relating to a plurality of host computers;
determine, by the resource optimization system, physical NIC queue requirements of a VCI;
select, by the resource optimization system, a target host computer for the VCI from the plurality of host computers based on the physical NIC queue availability information and the physical NIC queue requirements of the VCI; and
load, by the resource optimization system, the VCI on the target host computer.

18. The non-transitory computer-readable medium of claim 17, wherein the physical NIC queue availability information comprises one or more of:
a number of active physical NICs;
a number of available physical NIC queues for transmission or reception of data;
a number of available receive side scaling (RSS) engines corresponding to a given physical NIC;
a number of physical NIC queues in a given RSS engine corresponding to the given physical NIC; or
an association between a given physical NIC queue and a non-uniform memory access (NUMA) node.

19. The non-transitory computer-readable medium of claim 17, wherein the physical NIC queue availability information comprises information indicating an ability of one or more physical NICs to support pinning.

20. The non-transitory computer-readable medium of claim 17, wherein determining the physical NIC queue requirements of the VCI comprises determining a number of virtual NICs associated with the VCI.
